(19) United States
(12) Patent Application Publication
(10) Pub. No.: US 2018/0280776 A1
(43) Pub. Date: Oct. 4, 2018

(54) COMPETITIVE GAME AND METHOD OF PLAYING

(71) Applicant: Brandon Spady, Newport News, VA (US)

(72) Inventor: Brandon Spady, Newport News, VA (US)

(21) Appl. No.: 15/474,960

(22) Filed: Mar. 30, 2017

(51) Int. Cl. A63B 67/06; G09B 19/22; A63B 71/00; A63B 63/08

(52) U.S. Cl. CPC A63B 67/06; G09B 19/22; A63B 2209/00; A63B 63/08; A63B 71/0036

(57) ABSTRACT

A game comprises a plurality of containers positioned in a predetermined arrangement, wherein each of the plurality of containers is defined by a base and one or more sidewalls extending upward therefrom; and one or more balls, wherein the each of the plurality of containers is configured to receive the one or more balls, wherein the game is configured to be played by one or more users.

### CROSS-REFERENCE TO RELATED APPLICATION(S)

Not applicable

### BACKGROUND OF THE INVENTION

### 1. Field of Invention

The present invention relates to the field of games and methods of playing them. Specifically, to games involving skill.

### 2. Description of Related Art

Games bring people together. Whether the game is for simple entertainment or a competitive challenge, people participate due to a near instinctual drive for fun and excitement. While some games require skill or strategy and other games require luck, the present invention is directed to a game involving all three.

When a group of people get together a game is usually played. Board games are typically played where a party is kept indoors. However, parties and gatherings outside require a game with a larger presence and adaptability to the environment in which it is being played. Indoor games are relegated to indoors based on their need to be sheltered from environmental factors such as wind or the requirement for a level playing surface. This presents a problem for people wanting to enjoy what is generally an indoor game while they are enjoying a day at the beach or backyard.

When the party or gathering is outside, the physical elements of the game are generally cumbersome. Currently, games such as bag-toss require large wooden playing boards where users attempt to throw a bag through an opening in the upper playing surface. The playing board are heavy and require a lot of space for storage. The single opening also reduces the chances of success, which can lead to frustration.

Other outdoor games, such as horseshoes, require permanent installation. A playing field is established by having a post installed into the ground and a sand pit poured around the post. Wooden boards have to be constructed to form a backstop. A horseshoe is thrown at the post and the horseshoe is made of metal, which poses a danger to the players or spectators.

Based on the foregoing, there is a need in the art for a need for a game to be played outdoors with an easy setup, enjoyable playing method, and adaptability to address environmental concerns. A game is needed that allows users to play anywhere while not sacrificing the enjoyment of play.

### SUMMARY OF THE INVENTION

A game comprises a plurality of containers positioned in a predetermined arrangement, wherein each of the plurality of containers is defined by a base and one or more sidewalls extending upward therefrom; and one or more balls, wherein each of the plurality of containers is configured to receive the one or more balls, wherein the game is configured to be played by one or more users.

In an embodiment, each of the plurality of containers further comprises an opening into a hollow interior, wherein the opening is defined by a rim.

In an embodiment, the rim is a button, wherein if the rim is contacted by the one or more balls an indicator is triggered.

In an embodiment, the one or more balls comprises of one or multiple layers.

In an embodiment, the one or more balls are inflated.

In an embodiment, the arrangement comprises a generally triangular shape, wherein a first arrangement and a second arrangement are positioned across from one another at a predetermined distance.

In an embodiment, the game further comprises a frame configured to define a shape of the arrangement.

In an embodiment, the frame is inflatable.

In an embodiment, the one or more sidewalls are resilient, wherein the one or more sidewalls collapse towards the base when not in use.

In an embodiment, the game further comprises a carry device having an aperture extending into a hollow interior, wherein the hollow interior is configured to retain the plurality of containers and the one or more balls.

In an embodiment, the game is played using a method comprising the steps of: determining a shape of the arrangement; determining a distance between a first arrangement and a second arrangement, wherein the first arrangement and the second arrangement are the same shape, and wherein the first arrangement and the second arrangement are positioned opposite from one another; and a user throwing the one or more balls towards the opposite positioned arrangement, wherein if the one or more balls enters one of the plurality of containers a point is earned.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1 is a perspective view of the competitive game, according to an embodiment of the present invention;

FIG. 2 is a perspective view of the competitive game, according to an embodiment of the present invention;

FIG. 3 is a perspective view of the competitive game, according to an embodiment of the present invention;

FIG. 4 is a perspective view of the competitive game, according to an embodiment of the present invention;

FIG. 5 is a perspective view of the competitive game, according to an embodiment of the present invention;

FIG. 6 is a perspective view of the competitive game, according to an embodiment of the present invention;

FIG. 7 is a perspective view of the competitive game, according to an embodiment of the present invention;

FIG. 8 is a perspective view of the competitive game, according to an embodiment of the present invention;

FIG. 9 is a schematic view of the method of playing the competitive game, according to an embodiment of the present invention;

FIG. 10 is a schematic view of the method of playing the competitive game, according to an embodiment of the present invention.

### DETAILED DESCRIPTION OF PREFERRED EMBODIMENTS

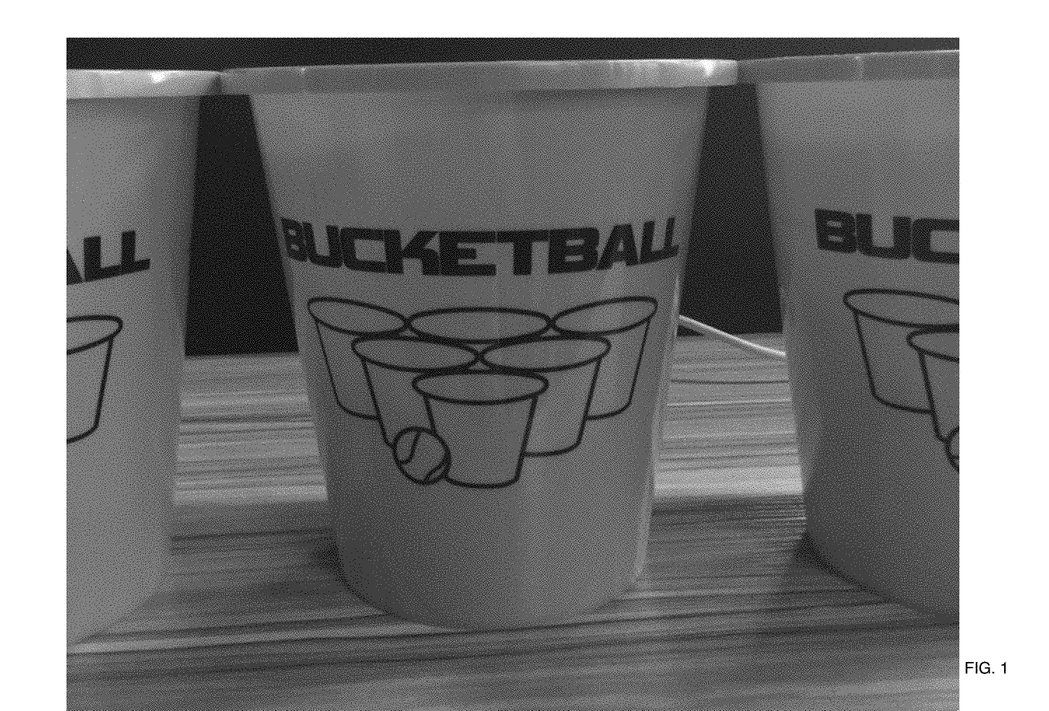

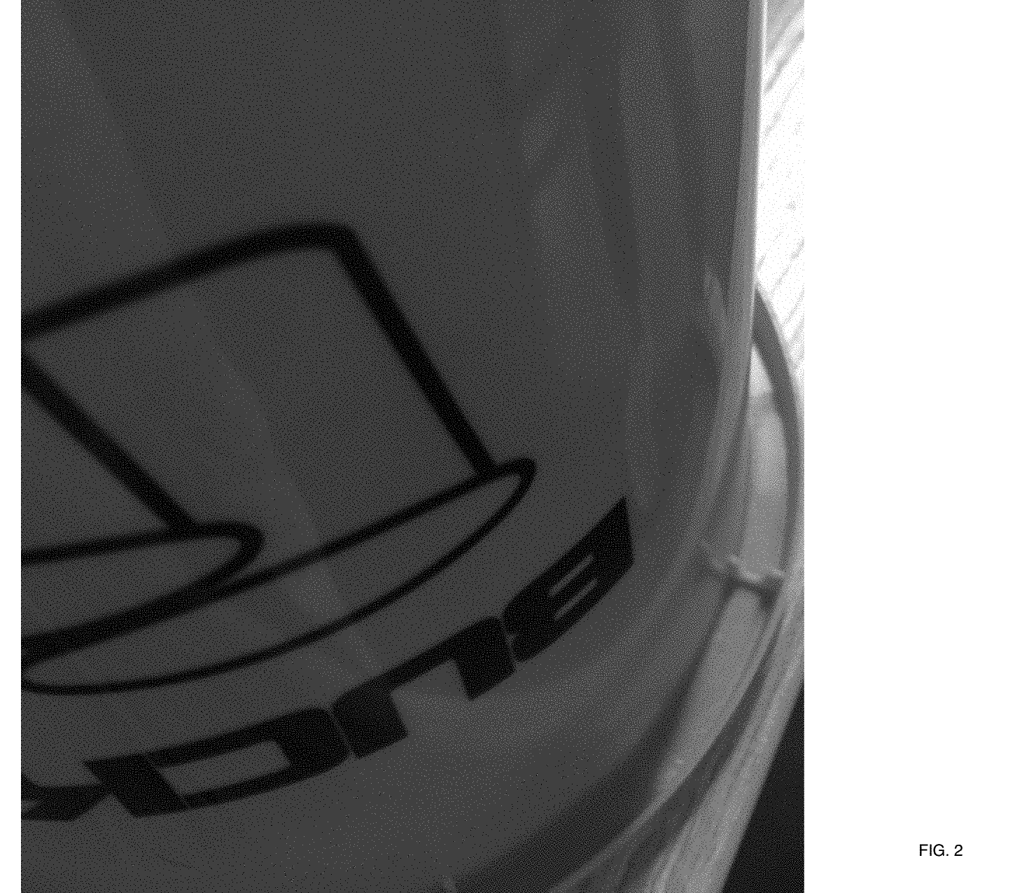

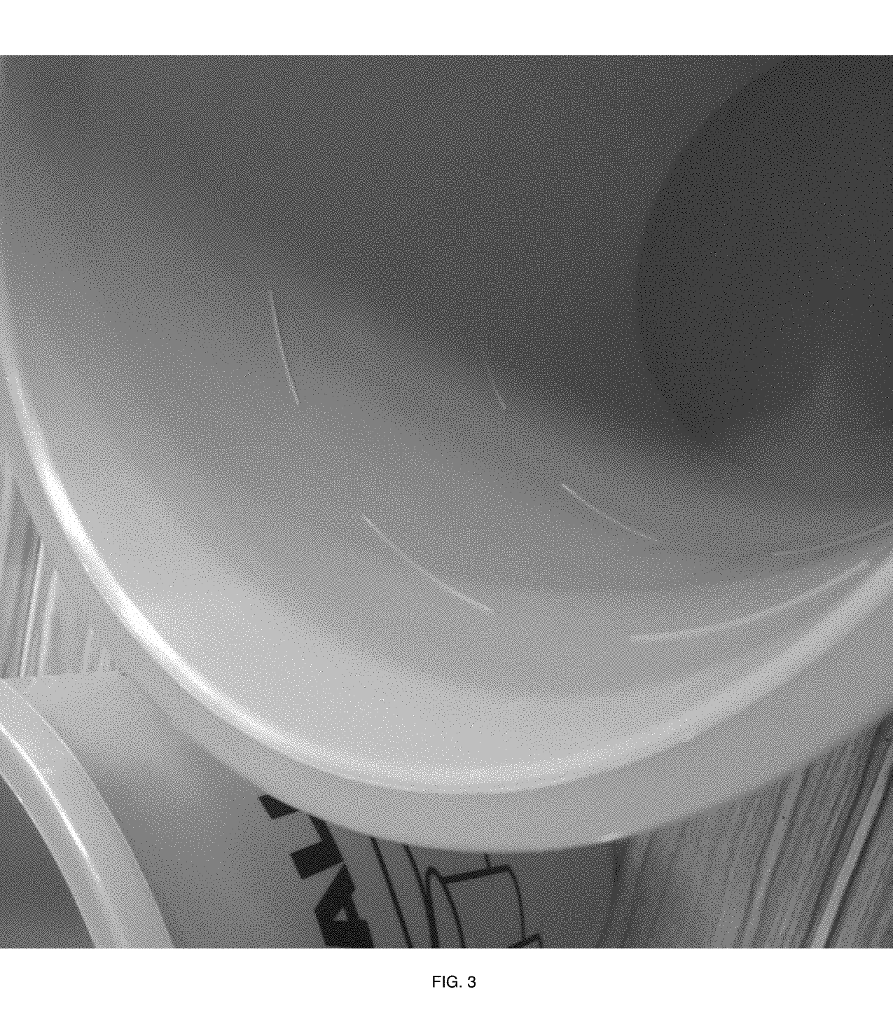

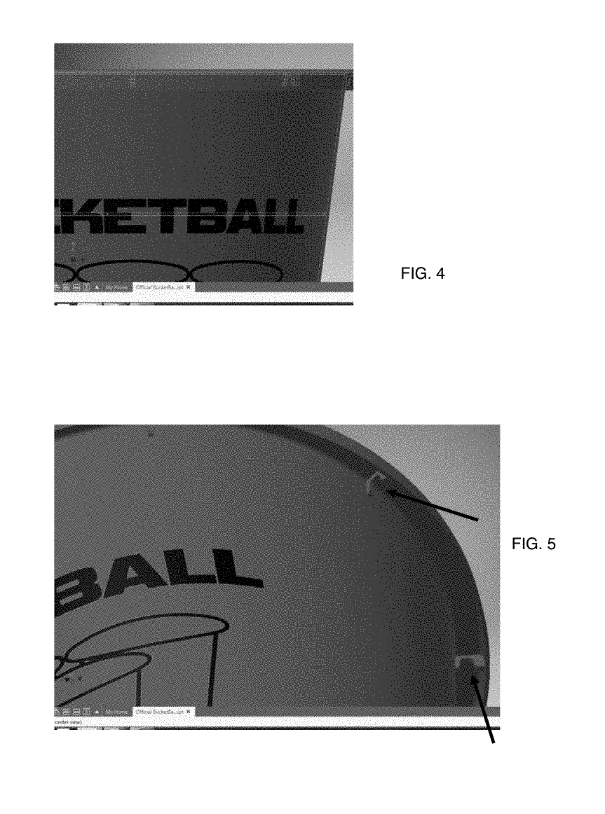

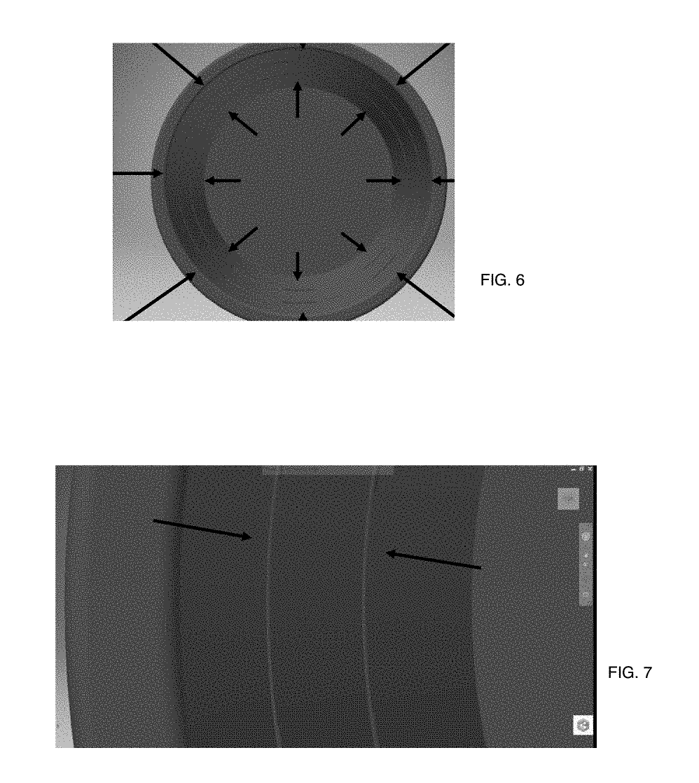

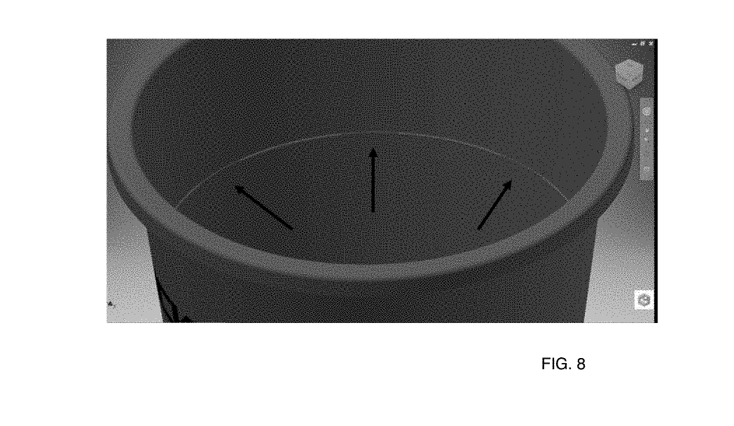

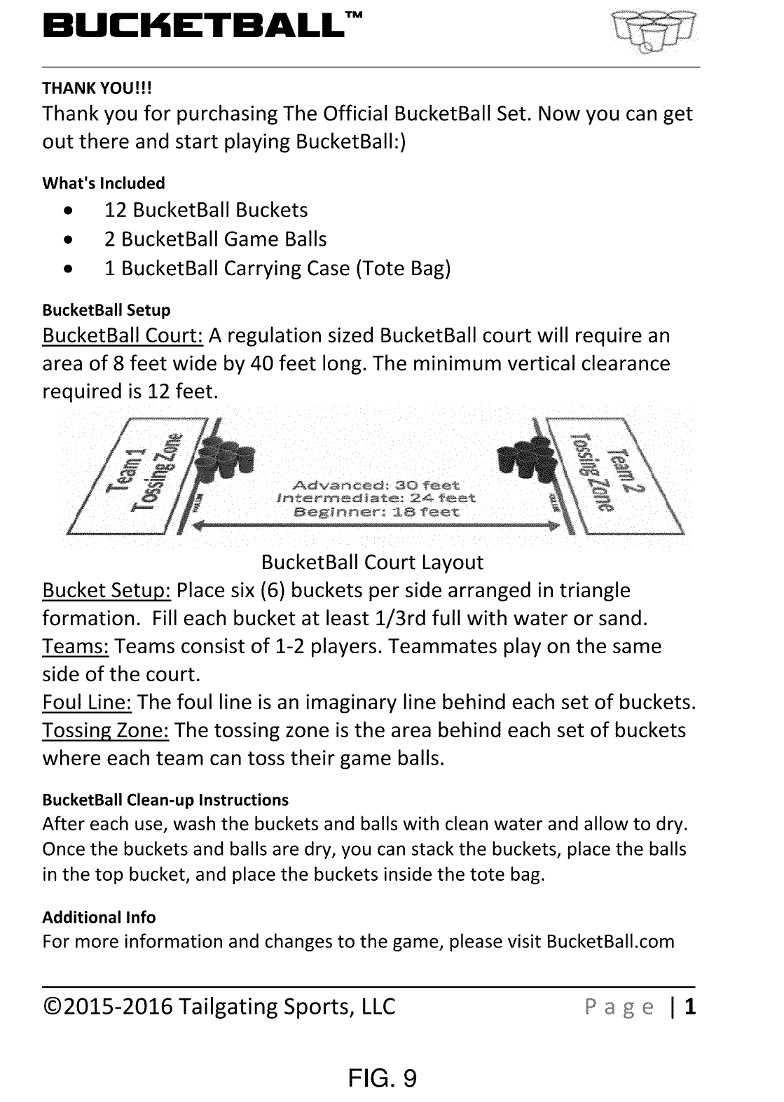

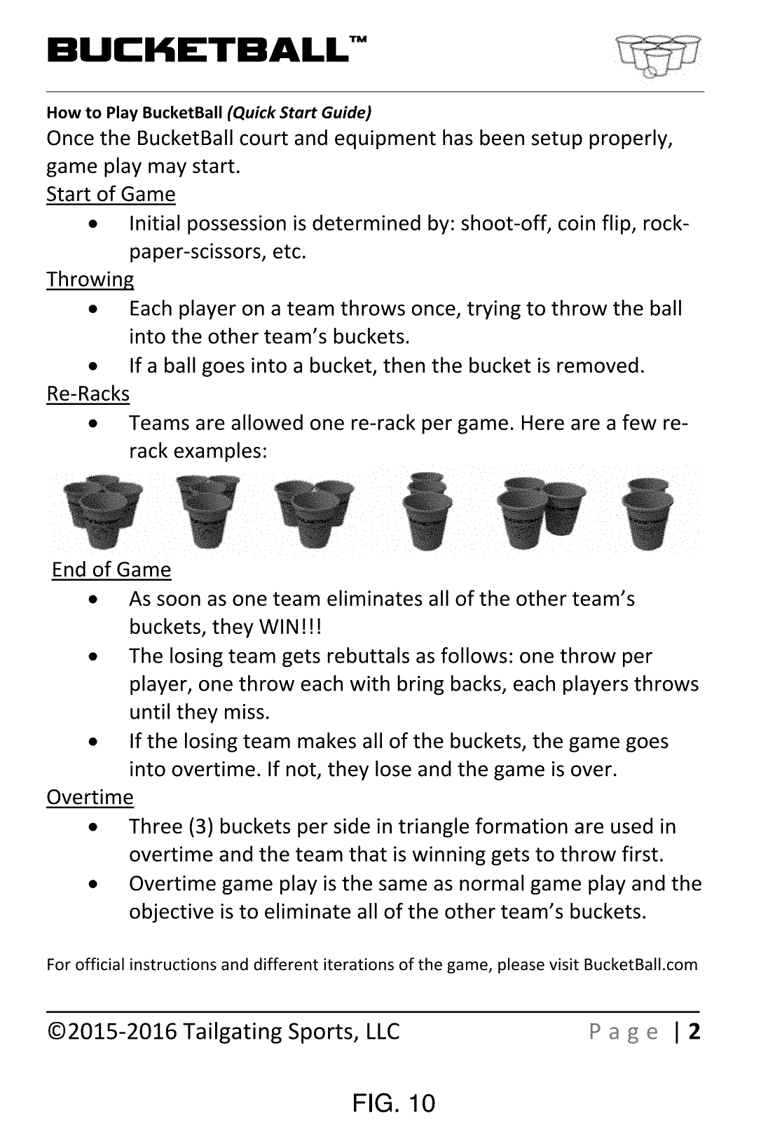

Preferred embodiments of the present invention and their advantages may be understood by referring to FIGS. 1-10, wherein like reference numerals refer to like elements.

The current game has at least one set of a plurality of openings arranged in a triangular pattern. A plurality of balls having a circumference smaller than the plurality of openings are provided for a user or player to throw towards the plurality of openings. In use, a player predetermines a trajectory for an intended path of one of the plurality of balls. Based on the trajectory, the player throws the ball with enough force to travel along the predetermined trajectory. If the ball passes through one of the plurality of openings, it is a success. If the ball misses or is not retained within the plurality of openings, it is a failure.

In an embodiment, there are at least two arrangements, each defined by a plurality of openings generally arranged in a triangular shape. The pair of arrangements are configured such that an angle of the triangular pattern is directly across from an angle of the other triangular pattern and the base of each triangle is parallel. A distance is predetermined between the two arrangements based on specific rules and regulations, or user preference.

In an embodiment, a container having a base and sidewalls extending upward therefrom defines each of the plurality of openings. The sidewalls extend upward and terminate in a generally circular shape providing for each of the plurality of openings. The arrangement is formed whereby each container is placed in close proximity to, or contacting the opening of other containers such that a triangle is formed. For example. A base of a triangular arrangement begins with three containers, a second level has two containers, and a third level has 1 container forming the third angle of the triangle.

In an embodiment, the containers are collapsible. The sidewalls are comprised of a fabric material having a structural frame system disposed therein. The frame system is configured to facilitate the collapse of each container such that the effective volume of the interior of each container is substantially reduced for improved transportation and storage.

In another embodiment, a frame is provided as a structural template for the positioning and placement of the containers. The frame has a perimeter based on the final configuration for the shape of the arrangement. Within the perimeter of the frame are dedicated locations for placement of each of the containers. For example, the frame has a triangular perimeter having dedicated locations identifying the levels as discussed above with a three container base, two container middle layer, and a single container pinnacle.

In an embodiment, each of the containers hold a volume of fluid greater than four quarts. The containers may be filled with fluid, solid, or weighted object(s) during game play to hold each container in contact with the ground. Fill indicators may be provided on an interior or exterior surface of the sidewalls to indicate appropriate fill levels. The rim of each opening of each container may provide for a dampening means to reduce the elasticity of a collision with a ball. The dampening means is provided under the rim where the rim is defined by a curled edge of the circumferential perimeter of each opening. Within the rim are one or more tabs creating a buttress or bulkhead between the rim and the sidewall. Each tab is configured to transfer energy from a ball contacting the rim to the sidewall where the transferred energy is distributed. In another embodiment, the rim is disposed circumferentially around the sidewall. In such a configuration, the rim acts to reinforce the integrity of the sidewall.

In another embodiment, the perimeter of each container is connected to a nearby contacting container within the arrangement. A clip is provided to connect contacting containers. The clip is generally U-shaped and is installed by inverting the shape such that the trough spans the distance between the contacting container being attached.

In yet another embodiment, the bottom of each of the containers may have a weight integrated into the base of each container. The weight may be disposed between a first layer of the base and a second layer of the base. The weight would be sufficient to overcome the force of a ball being thrown therein.

In an embodiment, each of the containers has an attachment means disposed on an external surface of the base. The attachment means is configured to affix or releasably attach each container to a playing surface. As a ball is thrown at the container, the attachment means prevents them from becoming dislodged or otherwise knocked over.

In an embodiment, the attachment means is at least one spike or anchor extending outward from the external surface of the container. The spike may be integrated or releasably attached to the bottom of a container allowing a user to put pressure on the container during placement such that the spike penetrates the ground the container is being placed in. Where the spike is releasably attached, the base of a container has a first attachment element and the spike has a second attachment element configured to engage the first attachment element. The first attachment element may be a clip, friction engagement, or hook and loop attachment allowing a spike to positively engage the base of the container such that the container is retained in its installed position.

In an alternative embodiment, the attachment means is a helical protrusion extending from the base. For installation, a user initially contacts the ground with the terminal end of the helical attachment and begins to rotate the container such that the helical end is driven further below the surface of the ground. This is especially helpful where the ground is sand.

In another embodiment, the plurality of openings is defined by a single structure. The single structure defines a playing surface whereby a plurality of apertures extend into the structure. For example, the structure may be generally triangular shaped and the apertures would extend through in a similar patter, as discussed above where three apertures are provided at a first base layer, two apertures are provided as a second layer, and a single aperture at the pinnacle of the triangle. Each of the apertures are separated by or clearly defined by a rim.

In an embodiment, the single structure is inflatable whereby a user inflates the structure to create a rigid playing surface and creating rigid apertures. In this embodiment, the user throws one or more of the balls towards the aperture. The ball either successfully enters and is retained within one of the apertures or is deflected by another part of the inflatable structure.

In another embodiment, the single structure is affixed to the ground using one or more tethers having a first end attached to the structure and a second end configured to engage the ground. For example, three tethers may be provided for a triangular structure whereby there is one tether at each of the three angles. The second end of each tether is pulled away from the structure and attached to the ground such that the tether line is taught between the two ends thereby securing the structure to the ground or playing surface.

In an alternative embodiment, each of the containers, openings, and/or frame have a light source attached to a power source container therein. The light source illuminates all or a portion of the container or structure to indicate appropriate ball placement in low-light or night settings. Alternatively, the light source may be illuminated based on interaction with ultraviolet (UV) light where energy is obtained from UV exposure resulting in illumination.

In another embodiment, the rim of each container acts as a button controlling the illumination within the container such that when a ball contacts the rim, the button is depressed and the container is illuminated for a preset amount of time. Such an embodiment provides for an additional game play feature allowing an opposing user improved visibility of the container after a shot.

The balls are generally spherical having an exterior surface. Where each of the balls are constructed of a resilient material, they provide for a partially elastic collision when they contact the plurality of openings.

In an embodiment, each of the balls has multiple layers starting at or near its core or center followed by concentric spherical layers until the outer surface. At least one of the layers provides for a weighted material having a higher density than other layers such that the ball is weighted. Exterior layers may provide for a rubberized or non-stick exterior surface. Another example of the exterior surface provides for a textured or fabric exterior surface. In one embodiment, the exterior surface of the ball is a portion of a hook and loop fastener whereby the single structure has only circular indicators reflecting where openings should be and the surface of the structure is the other portion of the hook and loop fastener.

In an alternative embodiment, each of the balls is filed with a granular material to provide weight and result in an inelastic collision with the containers. Alternatively, the interior of the balls may be filled with pressurized air or empty space resulting in a more elastic contact with the containers or structure.

Other illustrative examples of ball configurations include: hard and soft plastic balls. The plastic balls that may or may not have hole(s) to facilitate the introduction of air or other fluid. In some embodiment, the balls are inflatable balls or fabric balls (like hacky sacks).

In use, one user may play alone using a single arrangement or multiple users can play using multiple arrangements where the users are separated into teams. The arrangements are set some distance apart from one another. When teams are used, each team has an arrangement and they stand at or near their arrangement during gameplay. Initiating users are established before game play begins. The initiating users start by determining a trajectory of the ball based on the distance of the arrangement and the weight of the ball. The ball is then thrown along the trajectory. If the ball contacts a rim or the structure, that is it misses the opening, it is a failed attempt. Another team member preforms similar acts until the number of balls they are allotted are gone. The process is then repeated from the other team on the other side.

Where players successfully make a ball into the opening, the container may be removed or the opening of the single structure may be obstructed by a cover. In this way, the remaining openings are still viable options for gameplay. Play continues in this manner until all of the openings have been closed or removed from play.

In an embodiment, a container is provided to store and transport all of the components simultaneously. The container has an opening and an hollow interior to accommodate the playing components. One or more straps may be provided on an exterior of the container to engage a user while in use during transport.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

I claim:

1. A game comprising:
a. a plurality of containers positioned in a predetermined arrangement, wherein each of the plurality of containers is defined by a base and one or more sidewalls extending upward therefrom; and
b. one or more balls, wherein each of the plurality of containers is configured to receive the one or more balls, wherein the game is configured to be played by one or more users.

2. The game of claim 1, wherein each of the plurality of containers further comprises an opening into a hollow interior, wherein the opening is defined by a rim.

3. The game of claim 2, wherein the rim comprises of a plurality of tabs creating a buttress or bulkhead between the rim and the sidewall, wherein the plurality of tabs provide for a dampening means to reduce the elasticity of a collision with a ball, wherein the plurality of tabs provide spacing between the rims of adjoining containers where the base of one container is placed within the hollow interior of another container and the rims of those containers are separated by the plurality of tabs.

4. The game of claim 2, wherein the rim is a button, wherein if the rim is contacted by the one or more balls an indicator is triggered.

5. The game of claim 1, wherein the one or more balls comprises multiple layers.

6. The game of claim 1, wherein the one or more balls are inflated.

7. The game of claim 1, wherein the arrangement comprises a generally triangular shape, wherein a first arrangement and a second arrangement are positioned across from one another at a predetermined distance.

8. The game of claim 1, further comprising a frame configured to define a shape of the arrangement.

9. The game of claim 1, wherein the frame is inflatable.

10. The game of claim 1, wherein the one or more sidewalls are resilient, wherein the one or more sidewalls collapse towards the base when not in use.

11. The game of claim 1, further comprising a carry device having an aperture extending into a hollow interior, wherein the hollow interior is configured to retain the plurality of containers and the one or more balls.

12. The game of claim 1, wherein the game is played using a method comprising the steps of:
a. determining a shape of the arrangement;
b. determining a distance between a first arrangement and a second arrangement, wherein the first arrangement and the second arrangement are the same shape, and wherein the first arrangement and the second arrangement are positioned opposite from one another; and
c. a user throwing the one or more balls towards the opposite positioned arrangement, wherein if the one or more balls enters one of the plurality of containers a point is earned.
